(19) United States
(12) Patent Application Publication
(10) Pub. No.: US 2004/0201433 A1
(43) Pub. Date: Oct. 14, 2004

(54) Method of fine tuning a thermally tunable superconductor filter

(76) Inventors: Hao-Jung Li, Taipei City (TW); Kuo-Yang Horng, Dasi Township (TW); Chung-Hsi Liang, Jhongli City (TW)

Correspondence Address: J.C. Patent, Inc., Suite 250, 4 Venture, Irvine, CA, 92618, US

(21) Appl. No.: 10/753,722

(22) Filed: Jan. 8, 2004

(30) Foreign Application Priority Data
Apr. 12, 2003 (TW) 92134138

(51) Int. Cl. H01P 1/20; H01B 12/02

(52) U.S. Cl. 333/99 S; 505/210

(57) ABSTRACT

A method of fine tuning a thermally tunable superconductor filter. A HTS filter is placed in a vacuum condition at a superconductive transfer temperature, then the ambient temperature is reduced to a temperature lower than the superconductive transfer temperature. The dynamic inductance of a resonator inside the HTS filter is varied with the varying ambient temperature by controlling the thermal heater around the open end of the resonator, so as to tune the resonant frequency of the HTS filter.

### BACKGROUND OF THE INVENTION

1. Field of the Invention

The present invention relates to a method of fine tuning a superconductor filter, and more particularly, to a method of fine tuning a thermally tunable superconductor filter.

2. Description of the Related Art

The use of electrical appliances such as TV, PC, and lights are common in daily life. Although such electrical appliances provide us with significant convenience, over heating problem commonly occurs in electrical appliances when it is used for a long period of time. When it is used for too long, the electrical appliance may be over heated and breakdown. The root cause of such problem is due to a resistance, which is a phenomenon of resisting the movement of the electrons within the inner material structure of the conductive wire when electrons are flowing through the inter space of the conductive wire. In addition, the heating phenomenon caused by the resistance not only impact our daily life, but also wastes our useful energy resources. The yearly energy loss caused by wire heating is quite significant in its amount, thus it is common for the Power company to use high voltage transmission lines for delivering electricity in order to reduce the energy loss. However, the energy loss problem cannot be totally eliminated, the resistance of the transmission line yet causes energy loss, and the heat is yet generated when voltage is being converted into heat, thus it is still far from achieving the target of 100% energy utilization.

Obviously, a superconductor is a “super conductor” whose electrical conductivity is better than general conductors. When the temperature is lower than its superconductive transfer temperature (hereinafter, referred to as a Critical Temperature, Tc), the superconductor is provided with two characteristics, namely, Zero Resistance and Diamagnetism. In general conductor, the electron interacts with a symmetry structure (lattice) composed of the atoms inside the conductors as it passes through the conductor, the energy is then passed to the lattice structure through a lattice vibration and thereby causing the energy loss (heat). This describes a theory as to how the resistance is generated. In a metal conductor, the interaction level of the lattice and the electrical conductive electrons increases with the increase of the temperature, and thus its resistance increases with the increase of the temperature. However, in a semiconductor, the increase of the temperature facilitates in generating more electrical conductive electrons, and this effect is higher than the interaction of the lattice and the electrical conductive electrons, thus the resistance decreases with the increase of the temperature.

However, the electricity conduction phenomenon of superconductor is different from the electricity conduction phenomenon of general conductors. When the temperature is higher than its Tc, the superconductor behaves like the general conductor or semiconductor, meanwhile the resistance is still generated. However, when the temperature drops to a value below Tc, the movement of the electrons is hardly impacted by the lattice, that is, the resistance is totally eliminated, such phenomenon is the so-called Zero Resistance.

In addition, since the superconductor is so special in its electricity characteristics, it may also posses a special magnetic characteristic that is different from the general conductors. When the temperature of the superconductor is higher than its Tc, the external magnetic field freely passes through its inner space, in other words, the magnetic field exists in the superconductor. However, when the temperature is lower than Tc, all magnetic fields inside the superconductor are expelled in order to form a zero magnetic field effect, which is the so-called Diamagnetism. This phenomenon is disclosed by Meissner in 1933, thus it is called as a Meissner effect.

In early 20th century, along with the continuous progress of the superconductor research, it was found that many metals posses a superconductive characteristic under an extremely low temperature environment. Therefore, such metals can be appropriately mixed together to form an alloy in order to further improve its Tc. The highest Tc is found in Nb₃Ge, whose Tc is 23 K. Although attempts have been made to improve the Tc level of Nb₃Ge, but since its Tc value can not be high enough, and therefore it is not practically applied. However, in 1986, two Swiss scientists Muller and Bednorz discovered that the ceramic oxide La₂BaCuO₄, which was initially believed as not a good conductor of electricity, in fact posses an excellent superconductive characteristic possessing a Tc up to more than 30 K. The research is then focused on the study of the oxide superconductor. A couple of years in research and development, the Tc of a superconductor material HgBa₂Ca₂Cu₃O₈ was discovered to posses up to 135 K, and so far, the highest Tc of HgBa₂Ca₂Cu₃O₈ can be improved up to 160 K by processing the HgBa₂Ca₂Cu₃O₈ through a physical pressing method. In addition, since the structure of such high Tc superconductors is different from the structure of the alloy superconductor mentioned above, the scientists refer the alloy superconductor as a conventional superconductor or a low temperature superconductor, and refer the superconductor formed by the oxide as a high temperature superconductor. Since the discovery of the high temperature superconductor, this became a major topic of study and research in various countries in order to improve its practicality, thus its application field is gradually expanded, and the HTS filter is one of its practical applications.

A filter made of high Tc superconductor has low loss and sharp skirt characteristics and is applied in the receiving systems of mobile telecommunication base station and radar system for military application. However, the desired performance of the filter demands strict fabrication tolerances and it is often necessary to tune the center frequency of the filter because the center frequency of the filter varies from the expected design value due to the variation in permittivity of dielectric substrate and/or thickness of substrate.

Tuning of the center frequency has been achieved by through magnetic, electric and mechanical tuning methods. However, the use of magnetic tuning device incorporating ferrites has the disadvantages of large size and high insertion loss. The electrical tuning method has been found to seriously degrade the Q-factor of the resonator and deteriorate the filter characteristics. On the other hand, the mechanical tuning is performed by the tuning screw with less insertion loss. But it is hard to implement the mechanical tuning method in the filter design with high frequency and narrow band width because of the small size of the resonator.

### SUMMARY OF THE INVENTION

In the light of the above problems, one object of the present invention is to provide a method of fine tuning a thermally tunable superconductor filter for fine tuning the filter characteristic.

In order to achieve the above objects, the present invention provides a method of fine tuning a thermally tunable superconductor filter. A high temperature superconductive (HTS) filter is placed in a vacuum environment at a superconductive transfer temperature, and then the ambient temperature is reduced to a temperature lower than the superconductive transfer temperature. Meanwhile, due to the dynamic inductance of a resonator inside the HTS filter varies with the ambient temperature, and therefore the resonant frequency of the resonator can be fine tuned by varying the ambient temperature around the resonator.

In accordance with a preferred embodiment of the present invention, the dynamic inductance varies with the varying ambient temperature, and the dynamic inductance with the varying ambient temperature is distributed like a curve.

According to the present invention, since the dynamic inductance of the resonator is modified via a temperature controlled method, the resonant frequency of the HTS filter is tuned by modifying the dynamic inductance inside the high temperature superconductive material rather than being tuned by the fine tuning screw method.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic diagram illustrating a method of fine tuning a thermally tunable superconductor filter according to a preferred embodiment of the present invention.

FIG. 2 is a diagram illustrating the relationship between the dynamic inductance and the superconductive transfer temperature of the HTS filter.

### DESCRIPTION OF THE PREFERRED EMBODIMENTS

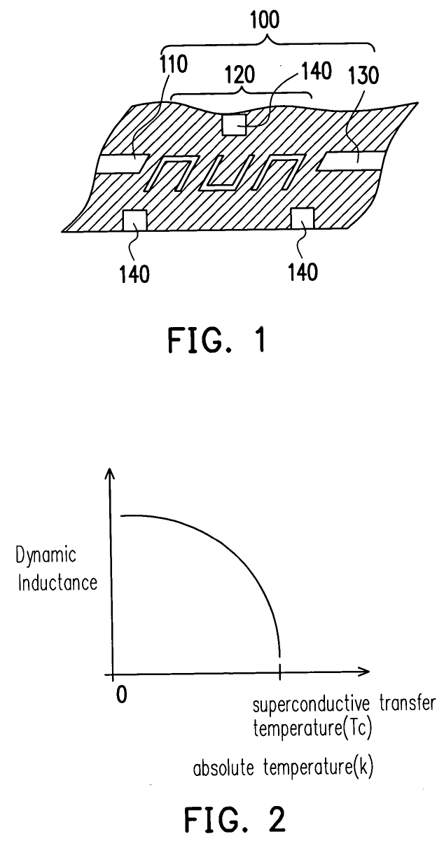

FIG. 1 is a schematic diagram illustrating a method of fine tuning a thermally tunable superconductor filter according to a preferred embodiment of the present invention. A HTS filter 100 is placed in a vacuum condition at a superconductive transfer temperature, wherein the HTS filter 100 is being fabricated through a semiconductor manufacturing process. The HTS filter 100 is formed on a high temperature superconductive material, e.g. an oxide material containing copper, and the superconductive transfer temperature Tc is higher than the low temperature superconductive material, thus it is suitable for manufacturing the passive device such as filters. Inside the filter 100, a resonant circuit fabricated by a semiconductor photolithography etching manufacturing process, essentially comprises an input terminal 110, a resonator 120, an output terminal 130 and a plurality of thermal heaters 140 as shown. A signal is input through the input terminal 110, which passes through the resonator 120 and reaches the output terminal 130, the resonator 120 is thus provided with a resonant frequency of a certain band, and wherein only the signal having resonant frequency of such band is allowed to pass there-through.

According to the conventional method disclosed by a U.S. Pat. No. 5,968,876, the resonator capacitance size of the HTS filter 100 is modified by using the manual fine tuning screw method for modifying the equivalent capacitance between the resonant circuit and the tuning screw. In other words, the capacitance between the resonant circuit and the tuning screw is tunable, when one end of the tuning screw is closer to the resonant circuit, the value of the equivalent capacitance increases. Therefore, the resonant frequency of the resonator decreases with the increasing equivalent capacitance, and on the other hand, the resonant frequency increases with the decreasing equivalent capacitance, and therefore the fine tuning of the resonant frequency can be achieved.

It is to be noted that the present invention differs from the conventional method, in that, according to the present embodiment, the ambient temperature is reduced to a temperature lower than the superconductive transfer temperature Tc, and the dynamic inductance of a resonator 120 inside the HTS filter 100 is varied by the ambient temperature so as to tune the resonant frequency of the resonator 120. FIG. 2 is a schematic diagram illustrating the relationship between the dynamic inductance and the superconductive transfer temperature of the HTS filter. As shown in FIG. 2, when the ambient temperature is lower than the superconductive transfer temperature Tc, the dynamic inductance at various the ambient temperature is distributed in a form of a curve showing that the dynamic inductance is temperature dependent.

Therefore, the present embodiment modifies the dynamic inductance of the resonator by using a temperature controlled method, such that the resonant frequency of the HTS filter 100 is tuned by varying the dynamic inductance inside the high temperature superconductive material rather than tuning the equivalent capacitance by using the manual fine tuning screw method. Therefore, the resonant frequency of the resonator 120 decreases with the increasing dynamic inductance, and on the other hand, the resonant frequency increases with the decreasing dynamic inductance, and accordingly, frequency of the resonant frequency can be tuned by varying the ambient temperature by controlling the temperature of the heater 140 shown in FIG. 1.

Presently the Proportional-Integral-Differential (PID) control technique is mature in the temperature control systems, which uses mathematical analysis for performing an automatic control to precisely control the temperature to the tune of ±0.01 K. Therefore, it is possible to achieve a desirable level of controlling the ambient temperature in vacuum condition using a PID control system as long as the PID control system is in good condition.

In summary, the conventional HTS filter uses the fine tuning design of the conventional filter to tune the resonant frequency, it is disadvantageous in its high cost and its ineffectiveness of performing a fine tuning and also due to the difficulty of manufacturing a more precise apparatus. However, the fine tuning method of the present invention is based on the material characteristic and the physical characteristic of the high temperature superconductive material, applying the appropriate circuit design theory to make a low cost HTS filter. Accordingly, the present invention provides a new method of tuning a thermally tunable superconductor filter comprising tuning the dynamic inductance of a resonator inside the superconductor filter by varying the ambient temperature so as to tune the resonant frequency of the resonator inside the superconductor filter.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method of fine tuning a thermally tunable superconductor filter, comprising:
placing a high temperature superconductive (HTS) filter comprising a resonator and a plurality of thermal heaters in a vacuum condition at a superconductive transfer temperature; and
varying a dynamic inductance of the resonator inside the HTS filter so as to fine tune a resonant frequency of the resonator by varying an ambient temperature around the resonator by controlling a temperature of the thermal heaters.

2. The method of fine tuning a thermally tunable superconductor filter of claim 1, comprising using a Proportional-Integral-Differential (PID) control method to fine tune the ambient temperature.

3. The method for fine tuning a thermally tunable superconductor filter of claim 1, wherein the ambient temperature is controlled within a temperature variation range of ±0.01 K.
